(19) United States
(12) Patent Application Publication
(10) Pub. No.: US 2024/0394511 A1
(43) Pub. Date: Nov. 28, 2024

(54) ENHANCED GENERATIVE AI MODEL TUNING

(71) Applicant: Accenture Global Solutions Limited, Dublin 4 (IE)

(72) Inventors: Vincent Thevenin, Courbevoie (FR); Alexandre Naressi, Valbonne (FR); Clement Rinaudo, Beausoleil (FR)

(21) Appl. No.: 18/485,299

(22) Filed: Oct. 11, 2023

(30) Foreign Application Priority Data
May 26, 2023 (EP) 23290019.1

(51) Int. Cl. G06N 3/0455; G06N 3/0895

(52) U.S. Cl. CPC G06N 3/0455; G06N 3/0895

(57) ABSTRACT

The present disclosure tunes a generative AI model using synthetic data. A system implementing a generative AI model may receive first input data. The first input data may include one or more rules. Based on the first input data, the system may generate an item of first synthetic data that complies with the one or more rules. Additionally, the system may receive second input data. The second input data may include a negation of the one or more rules received in the first input data, referred to as a modified set of rules. Moreover, the second input data may include the item of the first synthetic data. Based on the second input data, the system may generate an item of second synthetic data that violates the one or more rules. Subsequently, the system may tune the generative AI model based on the first synthetic data and the second synthetic data.

### CROSS-REFERENCE TO RELATED APPLICATIONS

The present application claims the benefit of priority from European Patent Application filed May 26, 2023 and entitled “ENHANCED GENERATIVE AI MODEL TUNING,” the disclosure of which is incorporated by reference herein in its entirety.

### TECHNICAL FIELD

The present disclosure relates generally to generative artificial intelligence (AI) models and more specifically, to enhancing operations of generative AI models through tuning.

### BACKGROUND

Generative AI has the potential to radically transform a wide range of tasks. However, current generative AI models have several inadequacies. For instance, some generative AI models require extensive, supervised training to automatically generate content in accordance with inputs or constraints provided to the generative AI. Providing the AI model with sufficient examples to enable the generative AI to automatically produce content in accordance with constraints is labor intensive and thus expensive. Moreover, such training-intensive generative AI models are susceptible to bias. For instance, if the training examples provided to the generative AI model are biased or skewed in a particular way, then the output produced by such generative AI models itself is likely to be biased. To illustrate, if input examples provided to a generative AI model are principally articles about cybersecurity rather than articles about marketing, then the generative AI model is likely to generate output with a preponderance of technical terminology as compared to marketing terminology.

Another inadequacy associated with current generative AI models is that if input data provided to the generative AI model is voluminous, then the generative AI model might have difficulty in applying the voluminous input data to generate an output. Additionally, such voluminous input data might significantly reduce a processing speed, a processing efficiency, or both such that the generative AI produces output after a substantial time lag, requires a large quantity of memory, processing resources, or both to process the voluminous data, uses a significant amount of energy to process the voluminous input data, or combinations thereof.

Attempts to cull the voluminous input data by removing certain items might result in output that is inaccurate, imprecise, or both. In particular, the removed or culled aspects of the voluminous input data may not be reflected in or taken into account by the learning algorithm, with the result that the learning algorithm may generate inaccurate or imprecise outputs. Producing distorted output should be avoided so as not to undermine confidence in the learning algorithm.

### SUMMARY

Disclosed herein are systems, methods, and computer-readable storage media that support tuning a generative AI model using synthetic data. A system of the present disclosure, such as a system implementing or instantiating a generative AI model, may generate synthetic data for use in training or tuning the generative AI model. For example, prompts may be provided to the generative AI model and the synthetic data may be generated by the generative AI model based on the prompts. The prompts may include a rules portion and a subject matter portion. The rules portion of the prompts may include one or more rules, such as rules governing generation of content using the generative AI model. The subject portion of the prompts may indicate what the content generated by the generative AI model should be directed to, such as a particular topic or subject matter. In accordance with aspects of the present disclosure, generation of synthetic data may be performed in stages. For example, a set of rules may be used to generate first synthetic data. The first synthetic data may include content generated by the generative AI model based on prompts that include at least a portion of the set of rules and may include subject matter covering one or more topics. A modified set of rules, which may be a set of rules representing a negation or inverse of the one or more rules received via the prompts used to generate the first synthetic data may be used to generate second synthetic data. The second synthetic data may include content generated by the generative AI model based on prompts that include at least a portion of the modified set of rules and may include subject matter covering the one or more topics. In this manner, the first synthetic data includes examples of content output by the generative AI model that complies with the set of rules and the second synthetic data may include examples of content output by the generative AI model that does not comply with the set of rules (i.e., due to the use of the modified set of rules in the prompts used to produce the second synthetic data).

The first synthetic data and the second synthetic data may form a set of training data that may be used to tune the generative AI model. For example, during tuning, the first and second synthetic data may be used to train the generative AI model to generate content that complies with the set of rules. For example, the first synthetic data may include x number of content examples covering y topics such that xᵢ represents a content example complying with the set of rules and covers topic i, where i=1 to y. Similarly, the second synthetic data may include x′ number of content examples covering the y topics such that x′ᵢ represents a content example that does not comply with the set of rules and covers topic i. Pairs of synthetic data may be formed based on the first and second synthetic data of the form (xᵢ, x′ᵢ). During tuning, a piece of second synthetic data x′ᵢ may be provided to the generative AI model and the corresponding piece of first synthetic data xᵢ may be the expected output. By tuning the generative AI model using the first and second synthetic data in this manner, the generative AI model may be trained to convert inputs that do not comply with the set of rules into content that does comply with the set of rules. In an aspect, the number of examples corresponding to each topic may be equal such that for a set of topics (Z), each topic (z) has a same number of examples xᵢ and x′ᵢ for each topic, thereby preventing the generative AI model from exhibiting topic bias when generating content. Once tuned, the generative AI model may be provided with prompts as input and may generate content that complies with the set of rules as an output. In this manner, a generative AI model may be trained to generate content complying with content generation rules, such as style guidelines, which may be used to automate generation of content for web pages, social media, blogs, or other types of content distribution media. It is noted that the above-described techniques can be applied to generative AI models that generate text-based outputs, as well as generative AI models that generate other types of content, such as 2-dimensional (2D) images.

In an aspect, a system for tuning a generative AI model using synthetic data includes a memory and one or more processors communicatively coupled to the memory. The one or more processors may be configured to generate a first set of synthetic data based on A set of rules using the generative AI model. The first set of synthetic data may include a first plurality of content outputs generated by the generative AI model, and the first plurality of content outputs may comply with the set of rules. Additionally, the one or more processors may be configured to generate a second set of synthetic data based on a modified set of rules using the generative AI model. The second set of synthetic data may include a second plurality of content outputs generated by the generative AI model. The second plurality of content outputs may comply with the modified set of rules but not the set of rules. Further, the one or more processors may be configured to tune the generative AI model using the first set of synthetic data and the second set of synthetic data to produce a tuned generative AI model configured to generate content that complies with the set of rules.

In an aspect, a method for tuning a generative artificial intelligence (AI) model using synthetic data is disclosed. The method may include generating a first set of synthetic data based on a set of rules using the generative AI model. The first set of synthetic data may include a first plurality of content outputs generated by the generative AI model, and the first plurality of content outputs may comply with the set of rules. Additionally, the method may include generating a second set of synthetic data based on a modified set of rules using the generative AI model. The second set of synthetic data may include a second plurality of content outputs generated by the generative AI model. The second plurality of content outputs may comply with the modified set of rules but not the set of rules. Further, the method may include using the first set of synthetic data and the second set of synthetic data to produce a tuned generative AI model configured to generate content that complies with the set of rules.

In an aspect, a non-transitory computer-readable storage medium storing instructions that, when executed by one or more processors, cause the one or more processors to perform operations for tuning a generative artificial intelligence (AI) model using synthetic data is disclosed. The operations may include generating a first set of synthetic data based on a set of rules using the generative AI model. The first set of synthetic data may include a first plurality of content outputs generated by the generative AI model, and the first plurality of content outputs may comply with the set of rules. Additionally, the operations may include generating a second set of synthetic data based on a modified set of rules using the generative AI model. The second set of synthetic data may include a second plurality of content outputs generated by the generative AI model. The second plurality of content outputs may comply with the modified set of rules but not the set of rules. Further, the operations may include using the first set of synthetic data and the second set of synthetic data to produce a tuned generative AI model configured to generate content that complies with the set of rules.

One or more features described herein may improve system operation as compared to conventional systems. For example, by providing a portion of a set of rules in or with input data, rather than most or all of the set of rules, fewer system memory and system processing resources are used than in conventional systems in which all or most of a set of rules are provided as input data in a first instance of time. Moreover, by iteratively including different portions or subsets of the set of rules in input data provided to the system over instances of time, the system may, eventually, be trained on most, if not all, of the rules, thereby preserving accuracy while conserving computational resources. Additionally, by tuning the system based on the first synthetic data and based on the second synthetic data, an accuracy of the results produced by the system may be enhanced over conventional systems, since the system is simultaneously trained on one or more examples that conform to the rules, such as first synthetic data, and one or more examples that violate the rules, such as second synthetic data.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram illustrating an example of a system that supports tuning a generative AI model using synthetic data according to one or more aspects of the disclosure;

FIG. 2A-2C are block diagrams illustrating an example procedure for tuning a generative AI model using synthetic data according to one or more aspects of the disclosure; and

FIG. 3 is a flow diagram illustrating an exemplary method for tuning a generative AI model using synthetic data according to one or more aspects of the disclosure.

It should be understood that the drawings are not necessarily to scale and that the disclosed aspects are sometimes illustrated diagrammatically and in partial views. In certain instances, details that are not necessary for an understanding of the disclosed methods and apparatuses, or which render other details difficult to perceive, may have been omitted. It should be understood, of course, that this disclosure is not limited to the particular aspects illustrated herein.

### DETAILED DESCRIPTION

Embodiments of the present disclosure provide systems, methods, and computer-readable storage media for tuning a generative AI model. In particular, aspects of the present disclosure provide new and enhanced tools for improving the performance of a generative AI model so that the generative AI model may produce outputs that conform to rules even though inputs provided to the generative AI model may not conform to rules. For instance, through application of the present disclosure, an AI model may be enhanced so that, in response to receiving input, such as textual input that fails to conform to one or more rules associated with content guidelines, such as grammatical, stylistic, or other guidelines governing content, the output generated by the AI model will conform to the one or more rules, even in situations when the rules are voluminous.

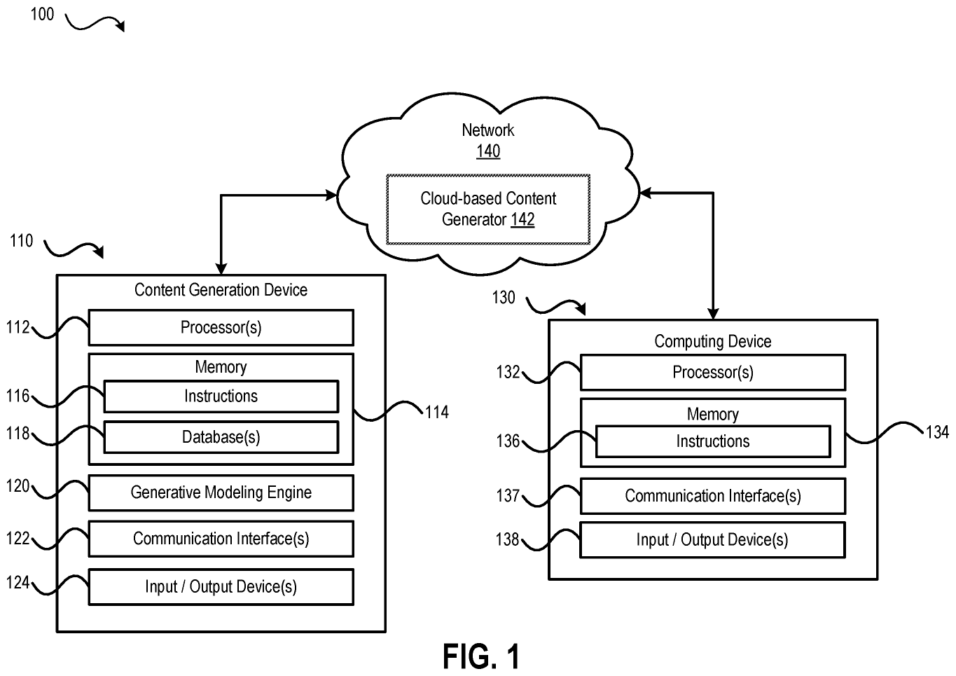

Referring to FIG. 1, a block diagram illustrating an exemplary system for tuning a generative AI model using synthetic data according to one or more aspects of the disclosure is depicted as a system 100. As shown in FIG. 1, system 100 includes content generation device 110. Although depicted as a singular device in FIG. 1, it should be understood that content generation device 110 may be implemented as part of a distributed system implementation including multiple content generation devices. Content generation device 110 may be communicatively coupled to one or more computing devices 130 via network 140. Exemplary functionality and operations of content generation device 110 are described in more detail below.

Content generation device 110 (e.g., an electronic device) may include or correspond to a server, a desktop computing device, a laptop computing device, a personal computing device, a tablet computing device, a mobile device (e.g., a smart phone, a tablet, a personal digital assistant (PDA), a wearable device, and the like), a virtual reality (VR) device, an augmented reality (AR) device, an extended reality (XR) device, other computing devices, or a combination thereof, as non-limiting examples. Content generation device 110 includes one or more processors 112 (collectively referred to as “processor 112”), one or more memories 114 (collectively referred to as “memory 114”), generative modeling engine 120, one or more communication interfaces 122 (collectively referred to as “communication interface 122”), and input/output devices 124 (collectively referred to as “I/O device 124”). Processor 112 may be communicatively coupled to memory 114, communication interface 122, I/O device 124, or combinations thereof.

In some other implementations, functionality of content generation device 110 may be implemented in a cloud-based deployment, such as cloud-based content generator 142. For example, in cloud-based content generator 142, any one or more of processor 112, memory 114, generative modeling engine 120, communication interface 122, I/O device 124, or combinations thereof may be deployed in or as separate components communicatively coupled via network 140. The foregoing components may be configured to perform one or more of the operations described herein.

Returning to the components of content generation device 110, processor 112 may include one or more microcontrollers, application specific integrated circuits (ASICs), field programmable gate arrays (FPGAs), central processing units (CPUs) having one or more processing cores, graphics processor units (GPUs), or other circuitry and logic configured to facilitate the operations of the content generation device 110 in accordance with aspects of the present disclosure. Memory 114 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the content generation device 110 may be stored in the memory 114 as instructions 116 that, when executed by processor 112, cause processor 112 to perform one or more operations described herein with respect to content generation device 110, as described in more detail below. Additionally, the memory 114 may be configured to store data and information in database 118 (e.g., one or more databases).

Generative modeling engine 120 may include or correspond to hardware, software, firmware, or a combination thereof that implement and/or instantiates a generative AI model. Generative modeling engine 120 may execute one or more AI algorithms configured to automatically generate output from provided input, possibly implementing zero shot learning techniques. Accordingly, generative modeling engine 120 may include or correspond to one or more AI algorithms configured to receive categories or classes of input, such as constraints, rules, images, text, speech, or any combinations thereof and may, subject to the one or inputted constraints, rules, or both, convert or transform the provided input into output that conforms to the inputted constraints, rules, or both. For example, these one or more AI algorithms may include or correspond to machine learning algorithms, neural networks, Bayesian networks, hidden Markov models, support vector machines (SVMs) or combinations thereof. In some implementations, generative modeling engine 120 may include or correspond to a large language model (LLM), an image generator model, a video generator model, or a combination thereof. Examples of LLMs include GPT-3, LaMDA, ESMFold, Gato, and WuDao 2.0. While generative modeling engine 120 is depicted as a separate component from processor 112 and instructions 116, processor 112 executing instructions 116 may be configured to implement the functionality of generative modeling engine 120, such as by instantiating generative modeling engine 120.

Communication interface 122 (e.g., one or more communication interfaces) may be configured to communicatively couple content generation device 110 to one or more networks via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, Bluetooth, Zigbee, and the like). In some implementations, the content generation device 110 includes one or more input/output (I/O) devices that include one or more display devices, a keyboard, a stylus, one or more touchscreens, a mouse, a trackpad, a microphone, a camera, one or more speakers, haptic feedback devices, or other types of devices that enable a user to receive information from or provide information to content generation device 110. In some implementations, content generation device 110 is coupled to a display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in content generation device 110.

Computing device 130 (e.g., an electronic device) may include or correspond to a server, a desktop computing device, a laptop computing device, a personal computing device, a tablet computing device, a mobile device (e.g., a smart phone, a tablet, a personal digital assistant (PDA), a wearable device, and the like), a virtual reality (VR) device, an augmented reality (AR) device, an extended reality (XR) device, other computing devices, or a combination thereof, as non-limiting examples. Computing device 130 includes one or more processors 132 (collectively referred to as “processor 132”), one or more memories 134 (collectively referred to as “memory 134”), one or more communication interfaces 137 (collectively referred to as “communication interface 137”), and one or more input/output devices (collectively referred to as “I/O device 138”).

Processor 132 may include one or more microcontrollers, application specific integrated circuits (ASICs), field programmable gate arrays (FPGAs), central processing units (CPUs) having one or more processing cores, or other circuitry and logic configured to facilitate the operations of the computing device 130 in accordance with aspects of the present disclosure. Memory 134 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the computing device 130 may be stored in the memory 134 as instructions 136 that, when executed by processor 132, cause processor 132 to perform one or more operations described herein with respect to computing device 130, as described in more detail below.

Content generation device 110 and computing device 130 may be communicatively coupled via one or more networks 140 (collectively referred to as “network 140”). The one or more networks 140 may include local area networks (LANs), wide area networks (WANs), wireless WANs, wireless LANs (WLANs), metropolitan area networks (MANs), wireless MAN networks, cellular data networks, cellular voice networks, the Internet, other types of public and private networks, or a combination of different network types and topologies. Additionally, the functionality of content generation device 110 may be implemented in a cloud based manner, such as by cloud-based content generator 142, as explained above.

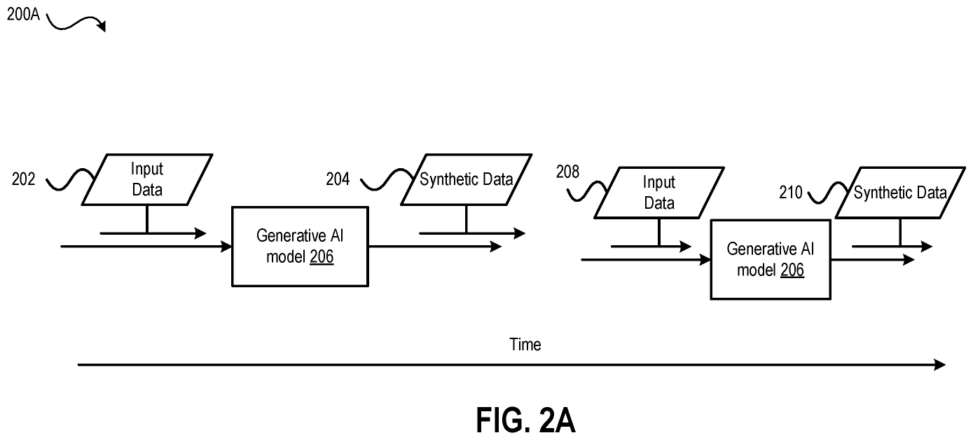

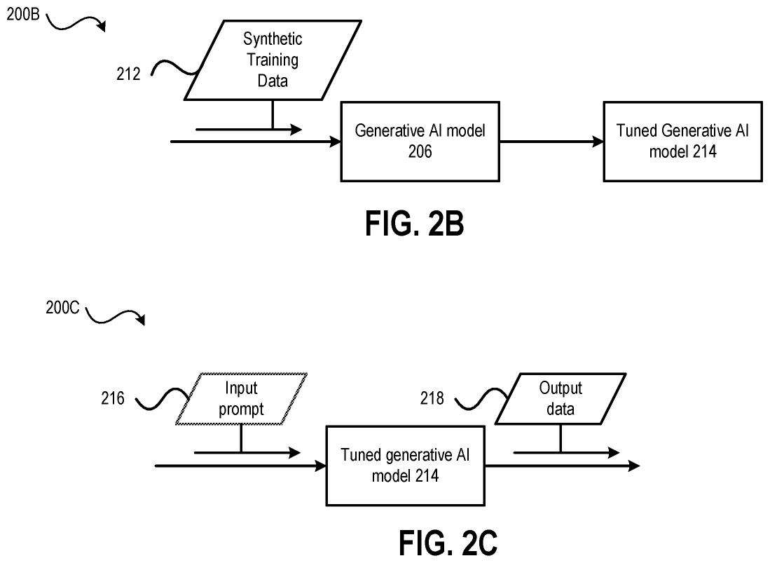

An exemplary cycle of operation of system 100 is described with reference to 2A-2C, which are block diagrams illustrating an example procedure for tuning a generative AI model using synthetic data and using the tuned generative AI model to produce content according to one or more aspects of the disclosure. Referring to FIG. 2A, a process for generating synthetic data is shown as process 200A. Process 200A may be utilized to generate synthetic data 204, 210 based on input data 202, 208. During process 200A, generative modeling engine 120, implementing generative AI model 206, may be configured to receive input data 202, 208, or both. In an aspect, input data 202, 208 may be received via a communication interface (e.g., communication interface 122 of FIG. 1), such as from a user device (e.g., computing device 130 of FIG. 1). In an additional or alternative aspect, input data 202, 208 may be received via an I/O device (e.g., I/O device 124 of FIG. 1). Generative AI model 206 may include or correspond to the one or more AI algorithms described with reference to FIG. 1. In particular, generative modeling engine 120 may be configured to implement or instantiate generative AI model 206, as explained with reference to FIG. 1. For example, processor 112 implementing instructions 116 may be configured to implement or instantiate generative modeling engine 120, which may include or correspond to generative AI model 206.

Input data 202 may include one or more prompts provided to generative AI model 206. The one or more prompts may include one or more rules of a set of rules. Additionally, the one or more prompts may include one or more instructions provided to generative AI model 206. The one or more instructions may cause generative AI model 206 to generate output directed to or about one or more topics or subjects. For example, a prompt may include or correspond to the following: an instruction, such as “write a paragraph on topic x”, where topic x is selected from a set of topics X; and rules, such as be direct, be concise, write in the active voice. It is noted that the exemplary rules described herein are provided by way of illustration, rather than by way of limitation and that other rules may be utilized in accordance with the concepts disclosed herein. In an aspect, the one or more instructions may cause generative AI model 206 to generate output targeted to one or more types of audiences. For example, the audience may be the general public, a university educated audience without a technical background, a corporate board, or another target audience. In an aspect, the prompt may also specify a type of content to be produced, such as a blog post, a social media post, a press release, an e-mail, or another type of content. The prompt may additionally include parameters related to a length of the content, such as to limit the content to a single paragraph, 2 paragraphs, 1 page, a specific number of characters, or other content length formats and specifications. In an aspect, the content length formats or specifications may be part of the rules.

The one or more rules of the set of rules included in input data 202 may include rules for generation of textual content, rules for generation of image content, rules for generation of video content, rules for generating audio content, or combinations thereof. As an example, the one or more rules of the set of rules included in input data 202 may include or correspond to content guidelines. The content guidelines may include or correspond to an organization's guidelines governing the style of written, visual, or audio content, the subject matter of written, visual, or audio content, or combinations thereof. For instance, the content guidelines may include or correspond to a manual of usage or style governing the grammar, style, subject matter, or combinations thereof of written content. As another example, the one or more rules of the set of rules corresponding to content guidelines may include rules governing the artistic style, subject matter, or both of images (e.g., such as requiring a logo to be included in a particular location of the image, use of certain color schemes (e.g., specific colors used by a company in branding materials), acceptable content that may be included in the image, or other content guidelines or rules), a size of the image, and the like. An additional example of the one or more rules of the set of rules corresponding to content guidelines may include rules governing the style, content, or both of audio data, such as rules requiring use of certain musical genres, prohibitions on use of profanity or slang terms, and the like.

The one or more instructions provided to generative AI model 206 may include or correspond to a command to generate text, an image, audio content, or a combination thereof. Additionally, the one or more instructions may identify a topic or subject about which the content is to be generated. Moreover, the one or more instructions may identify an audience for which the content is to be generated. For example, the topic or subject may include or correspond to information about a sport, current affairs, the economy, a technical topic, a subject of interest to a user of content generation device 110, or any combination thereof.

Generative AI model 206 may be configured to generate, based on input data 202, synthetic data 204. In particular, multiple instances of input data 202 may be provided to generative AI model 206, and generative AI model 206 may be configured to generate multiple instances of synthetic data 204 based on the multiple instances of input data 202. The multiple instances of synthetic data 204 may include or correspond to a first set of synthetic data. The first set of synthetic data may cover different topics, may be generated based on different portions of the set of rules, may be directed to different types of audiences, or a combination thereof. In instances where multiple topics are covered by the multiple pieces of input data 202, the topics associated with each of the multiple pieces of input data 202 provided to the generative AI model 206 may be controlled to ensure that the number of pieces of input data 202 covering each topic are even, so as to avoid topic bias. In an aspect, the topics associated with each piece of input data 202 may be configured manually. For example, where the multiple pieces of input data 202 are to cover 5 topics, a user may configure the pieces of input data 202 such that each topic is covered in “A” pieces of input data 202, where A>0. In an additional or alternative aspect, the topics associated with each piece of input data 202 may be configured automatically. For example, a data domain may be crawled or scraped to identify topics within the data domain. Once the set of topics within the data domain is identified, multiple pieces of input data 202 may be generated, where the number of pieces of input data 202 are configured to evenly cover the set of topics.

Generative AI model 206 may generate synthetic data 204 for each based input data 202. Each piece of synthetic data 204 may include or correspond to output that conforms to the portion of the set of rules included in the corresponding input data 202 and may contain content based on the instructions of the prompt. For instance, if input data 202 includes or corresponds to a set of content guidelines, such as a manual of usage or style governing the grammar, style, subject matter, or combinations thereof of written content, the first plurality of content outputs (e.g., the synthetic data 204) may include a phrase, a sentence, a paragraph, textual content, or combinations thereof that conform to the manual of usage or style constituting input data 202. As another example, if input data 202 includes or corresponds to a set of content guidelines governing the subject matter, artistic style, or both of images, the content outputs generated based on the input data 202 may include an image, a fragment of an image, or both that conform to content guidelines constituting input data 202. In yet another example, if input data 202 includes or corresponds to a set of content guidelines governing the subject matter, style, or both of audio content, the content output by generative AI model 206 may include one or more audio files that conforms to content guidelines reflected in input data 202.

In an aspect, the portion of the set of rules associated with each input data 202 may be determined by sampling the set of rules so that a different portion or subset of the set of rules is provided to generative AI model 206 as part of each input data 202, such as in a prompt. Different sampling algorithms may be deployed to sample the set of rules. For instance, the set of rules may be uniformly sampled without replacement (e.g., the set of rules may be sampled only once). In this manner, datasets may be generated that cover an entire set of rules uniformly. Additionally or alternatively, the sampling may generate multiple pieces of input data 202 associated with each sampled rule or rule portion such that multiple input data 202 are generated for each rule of the set of rules or each portion of the set of rules, thereby creating a larger set of input data 202 covering the entire set of rules uniformly. In the examples above, each input data 202 may be associated with parameters or instructions. As described above, the parameters or instructions may identify a topic associated with the content to be generated by the generative AI model 206, a target audience for the content, length parameters for the content, or other information that may be used by the generative AI model 206 to generate a piece of synthetic data 204 for each piece of input data 202.

As a non-limiting an illustrative example of the sampling techniques described above, generative modeling engine 120 of FIG. 1, processor 112 of FIG. 1, or a combination thereof may be configured to implement or instantiate an operation or function P to parse rules, instructions, or both, collectively designated Rᵢ, to generate a set of all rules, instructions, or both, S_{i,n}. The foregoing operation or function may be denoted, mathematically, as S_{i,n}⊂P(Rᵢ), where |S_{i,n}|=n. Subsequently, generative modeling engine 120, processor 112, or a combination thereof may be configured to uniformly sample the set of all rules, instructions, or both, S_{i,n}, to extract a particular group or subset of the rules, instructions, or both, an operation denoted, mathematically as rᵢ˜ Uniform (S_{i,n}). Subsequently, one or more prompts containing portions or subsets of the rules many be generated in which, mathematically, each prompt=∩ᵢrᵢ. In this manner, input data 202 may be generated that includes different portions or subsets of the rules, instructions, or both. For instance, a first subset of the rules may be R1={“be direct,” “be concise,” “use an active voice”}, a second subset of the rules may be R2={“write on the topic of AI,” “write on the topic of cybersecurity,” “write on the topic of life sciences”}, and a third subset of the rules may be R3={“write for audience A,” “write for audience B”).

In addition to generating, based on input data 202, synthetic data 204 which complies with the set of rules (or portion thereof), process 200A may also generate input data 208, which may be used to generate additional synthetic data, shown in FIG. 2A as synthetic data 210. Input data 208 may include prompts similar to those described above with reference to input data 202, such as prompts including one or more rules and instructions. However, unlike the input data 202, the rules included in the input data 208 may be associated with one or more modified rules of a modified set of rules. The modified set of rules may include or correspond to a negation of one or more rules of the set of rules included in input data 202, and the one or more modified rules included in each piece of input data 208 may include or correspond to a negation of the one or more rules included in a corresponding piece of input data 202. For example, suppose a piece of input data 202 includes one or more rules Rx and instructions I (e.g., write on topic i₁). A corresponding piece of input data 208 may include a negation or inverse of Rx (e.g., −Rx) and instructions I. Accordingly, the input data 202, when passed to the generative AI model 206 may produce synthetic data 204 that includes content in accordance with I and that complies with Rx, while input data 208, when provided to the model 206, may produce output data 210 that includes content in accordance with I and that does not comply with Rx (e.g., because the rules (−Rx) of the input data 208 represent a negation or inverse of the rules Rx).

Since input data 208 may be generated by negating the rules included in input data 202, if input data 202 includes only a subset or portion of the rules, input data 208 may, likewise, include only a subset or a portion of the modified rules, which may then be provided to generative AI model to generate synthetic data 210. By iteratively and periodically sampling input data 202, such as rules, over a plurality of iterations, the totality of rules corresponding to input data 202, may be sampled such that synthetic data 204, 210 may include or correspond to a first plurality of outputs and a second plurality of outputs, respectively, that includes instances of compliance associated with each rule of the set of rules and non-compliance associated with each rule of the set of rules.

In generating negative prompts, generative modeling engine 120, processor 112, or a combination thereof may be configured to implement or instantiate an operation or function P to parse a negation of rules, instructions, or both, collectively designated R_{negi}, to generate a negation of the set of all rules, instructions, or both, S_{i,n}. The foregoing operation or function may be denoted, mathematically, as S_{i,n} ⊂P(R_{negi}) where |S_{i,n}|=n. Subsequently, generative modeling engine 120, processor 112, or a combination thereof may be configured to uniformly sample the set of all of the negation of the rules, instructions, or both, S_{i,n}, to extract a particular group or subset of the negation of the rules, instructions, or both, an operation denoted, mathematically as rᵢ˜Uniform (S_{i,n}). Subsequently, one or more prompts containing portions or subsets of the rules many be generated in which, mathematically, each prompt=∩ᵢrᵢ. In this manner, input data 208 may be generated that includes different portions or subsets of the negation of rules, instructions, or both. For instance, considering the above example, a first subset of the rules may be modified to generate a negation of these rules such that the first subset of the modified rules may be −R1={“be indirect,” “be verbose,” “use passive voice”}. In an aspect, only a portion of the set of rules may be negated. For example, the second and third subsets may be maintained as constants (e.g., may not be negated) such that the second subset of the modified rules may be denoted R2={“write on the topic of AI,” “write on the topic of cybersecurity,” “write on the topic of life sciences”} and a third subset of the rules may be R3={“write for audience A,” “write for audience B”}. By only negating the rules R1, which may relate to rules for controlling style, the generative AI model may be trained with respect to stylistic generation of content, such as generating new content in a desired style and/or stylistic rephrasing of content, while keeping other rules of the set of rules the same, such as topic and audience rules. It is noted however, that negation of rules may be performed with more than just stylistic rules depending on the types of learning desired for a given generative model. For example, combinations of both style rules and audience rules may be negated to train the generative model to generate content using different styles for different audiences.

Generative AI model 206 may be configured to generate, based on input data 208, synthetic data 210. In particular, multiple instances of input data 208 may be provided to generative AI model 206, and generative AI model 206 may be configured to generate multiple instances of synthetic data 210 based on the multiple instances of input data 208. The multiple instances of synthetic data 210 may include or correspond to a second set of synthetic data. The second set of synthetic data may include or correspond to a second plurality of content outputs generated by generative AI model 206. The second plurality of content outputs may comply with the modified set of rules, but may not comply with the set of rules. Since input data 208 may include synthetic data 204, in some implementations, synthetic data 210 (e.g., the second set of second synthetic data) may be generated based on the modified set of rules and synthetic data 204 (e.g., the first set of synthetic data). In aspects, generative AI model 206 may leverage zero shot capabilities of large language models (LLMs) to generate synthetic data 204, 210 based on input data 202, 208.

An example of the second plurality of content outputs generated by generative AI model 206 and included in synthetic data 210 may include or correspond to output that violates the content guidelines. To illustrate, if the content guidelines include or correspond to a manual of usage or style governing the grammar, style, subject matter, or combinations thereof of written content, the second plurality of content outputs may include a phrase, a sentence, a paragraph, textual content, or combinations thereof that violate one or more rules of the manual of usage or style. As another example, if the content guidelines govern the subject matter, artistic style, or both of images, the second plurality of content outputs may include an image, a fragment of an image, or both that violate one or more of the rules of the content guidelines. In yet another example, if the content guidelines govern the subject matter, style, or both of audio content, the second plurality of content outputs may include an audio file that violates one or more rules of the content guidelines. As can be appreciated from the description above, the process 200A may be utilized to generate synthetic data pairs that include synthetic data 204 and synthetic data 210. More particularly, the synthetic data pairs may include a piece of synthetic data 204 and a piece of synthetic data 210 representing the output of generative model 206 generated based on a negation of the input data 202 use to generate the piece of synthetic data 204. Thus, each synthetic data pair may represent an example output of generative AI model 206 that complies with the set of rules or portion thereof, and an example output of generative AI model 206 that does not comply with the set of rules or portion thereof (i.e., based on the negation of the rules to produce modified rules).

Referring to FIG. 2B, a process for tuning a generative AI model to produce a tuned generative AI model according to one or more aspects of the present disclosure is shown as process 200B. Process 200B may be performed by modeling engine 120, processor 112, or both of FIG. 1. Pairs of synthetic data 204 and synthetic data 208, collectively referred to as synthetic training data 212, may be provided to generative AI model 206 to generate tuned generative AI model 214. Each synthetic data pair of the plurality of synthetic data pairs may include first content output (e.g., a piece of synthetic data 204) and a second content output (e.g., a piece of synthetic data 210 representing the negation of the piece of synthetic data 204). For example, as shown in Table 1 below, the synthetic training data 212 may include n synthetic data pairs, where each pair includes a positive example representing a piece of synthetic data 204 and a negative example representing a piece of synthetic data 210.

TABLE 1

| Positive Example | Negative Example |
|---|---|
| Synthetic data 204₁ | Synthetic data 210₁ |
| Synthetic data 204₂ | Synthetic data 210₂ |
| Synthetic data 204₃ | Synthetic data 210₃ |
| . . . | . . . |
| Synthetic data 204ₙ | Synthetic data 210ₙ |

Synthetic training data 212 may be provided to generative AI model 206 to tune generative AI model 206, thereby resulting in a tuned generative AI model 214. To illustrate, a positive example of synthetic data may represent the desired output that is to be generated by generative AI model 206 when presented with a negative example. Thus, during tuning, a piece of synthetic data 210i may be provided to generative AI model 206 as an input with a paired piece of synthetic data 204i representing the desired output to be generated by the generative AI model 206. Generative AI model 206 may then process the negative example to produce an output corresponding to the positive example. As generative AI model 206 rewrites the negative example to conform to the positive example generative AI, model 206 learns the one or more rules associated the portion of the set of rules corresponding to the positive example. By providing each of the matched pairs of synthetic data 204 (positive examples) and synthetic data 210 (negative examples) to generative AI model 206, generative AI model 206 learns the entire set of rules, which are used to create the synthetic data 204, without providing the entire set of rules to generative AI model 206 in a single prompt. In an aspect, generative AI model 206 may utilize self-supervised learning to learn from outputs generated by the generative AI model, such as the synthetic training data described herein. Applying self-supervised learning is advantageous, because doing so obviates the inefficient process of manually gathering data, cleaning the manually gathered data, and preprocessing the manually gathered data.

Utilizing the above processes 200A and 200B, a tuned generative AI model 214 may be generated. Tuned generative AI model 214 may be configured to generate content that complies with the entire set of rules, such as the set of rules used to generate input data 202. Exemplary details regarding tuned generative AI model 214 are described in more detail below with reference to FIG. 2C. It is noted that if the set of rules changes, processes 200A and 200B may be performed to update the tuned generative AI model 214 (e.g., allow the tuned generative AI model 214 to learn the updated set of rules).

Referring to FIG. 2C, a process for generating content using a tuned generative AI model in accordance with one or more aspects of the present disclosure is shown as process 200C. As explained above, the tuned generative AI models generated in accordance with the concepts disclosed herein may be configured to output content that conforms to rules. For example, tuned generative AI model 214 may receive input prompt 216. Input prompt 216 may include or correspond to an instruction to generate an output. In response to receipt of input prompt 216, tuned generative AI model 214 may be configured to generate output that conforms to one or more rules, such as a set of content or style guidelines. For instance, input prompt 216 may include or correspond to text (e.g., a sentence, a paragraph, etc.) that may or may not comport with one or more rules in an organization's manual of usage or style. In response to receipt of input prompt 216, tuned generative AI model 214 may be configured to transform such content included with input prompt 216 into compliant output data 218. Thus, in the example of material included with input prompt 216 that includes or corresponds to text (e.g., a sentence, a paragraph, etc.) that fails to comport with one or more rules in an organization's manual of usage or style, output data 218 may include or correspond to text (e.g., a sentence, a paragraph, etc.) that comports with the one or more rules in the organization's manual of usage or style, thereby correcting any portions of input prompt 216 that violated the set of rules. As another example, input prompt 216 may include an instruction to generate output, such as text, about a particular topic for a particular audience. In response to receipt of input prompt 216, tuned generative AI model 212 may be configured to generate output data 218 that includes text about the particular topic for the particular audience that satisfies the rules (e.g., the organization's manual of usage or style).

Illustrative examples of input prompts 216, output data 218, and outputs of a generative AI model that has not been tuned in accordance with the concepts disclosed herein are shown below in Table 2. It is noted that, unlike the input data 202 of FIG. 2A, the input prompts 216 may not include information related to the set of rules and may instead only include information related to the content to be generated. Further, it is noted that, when the generative AI model has not been tuned in accordance with the concepts disclosed herein, as in the middle column of Table 2 (e.g., Generative AI Model (untuned)), all of the rules may be written directly in the prompt simultaneously, which is inefficient and more memory intensive.

TABLE 2

| | Generative AI Model | |
|---|---|---|
| Input Prompt 216 | (untuned) | Output Data 218 |
| The goal was to create an | Our goal was to build a | We set out to assemble a |
| ecosystem of internal and | collaborative network of | team of internal and |
| external talent that could | internal an external talent, | external experts who could |
| provide advisory services and | allowing us to provide expert | offer advice and swiftly |
| quickly design an prototype | advice and quickly develop | generate solutions. We |
| solutions. A five-year | and test ideas. So, we created | crafted a 5-year plan and |
| roadmap and interactive | a 5-year plan and a practical | accompanying book to |
| playbook were created to | instruction manual to make the | cultivate and spread our |
| industrialize and socialize the | new approach efficient and | new approach. |
| new strategy. | accessible. | |
| The strategy is designed to | This strategy seeks to facilitate | The company is |
| drive transformation along | a shift in four core areas in | undertaking a bold |
| four key dimensions, helping | order to move the company | strategy to revolutionize |
| the company transition from: | forward. It will foster | their operations, changing |
| | transformation, and prepare | their operations in the |
| | the firm for growth. | following ways: |
| This value-driven framework | This value-driver framework | Organizations can use this |
| aims to help organizations | helps organizations uncover | framework to determine |
| identify the value of | how blockchain can create | the potential value of |
| blockchain technology in | value in their use cases and | blockchain technology and |
| their use cases and build a | construct a realistic business | create a strong business |
| corresponding business case. | case. We look at key factors to | case for its use. |
| | determine the potential impact | |
| | of blockchain, identify the | |
| | business value that blockchain | |
| | can generate, and develop | |
| | strategies to maximize this | |
| | value. | |

As shown in Table 2 above, the tuned generative AI model can accept input prompt 216 and generate output data 218 that is different from the output obtained without tuning the generative AI model. For example, the outputs 218 in the examples above may be written in active voice rather than passive voice, may be more concise, and other differences. These differences may be the result of tuning the generative AI model using processes 200A and 200B above, resulting in a tuned generative AI model (e.g., the tuned generative AI model 214) that is configured to enforce rule sets that may be otherwise difficult for a generative AI model to learn.

As described with reference to FIG. 1-2C, the present disclosure supports tuning a generative AI model using synthetic data and provides several advantages over prior art systems. By including, in input data 202, input data 208, or both, a portion or subset of rules and modified rules, respectively, rather than an entirety of the rules in a set of rules, memory and processing resources of content generation device 110 are conserved. However, by iteratively and periodically sampling the rules, instances of synthetic data 204, 210 may be generated that, cumulatively, are indicative of an entirety of the set of rules. Accordingly, while computing resources (e.g., memory 114, processing functionality of processor 112) are conserved by processing the rules in batches and generating reciprocal modified data based on the batched processed rules, an accuracy and a precision of tuned generative AI model 214 is not sacrificed. In this manner, output data 218, generated by tuned generative AI model 214, is more likely to conform to the rules even when tuned generative model 214 is provided with input prompt 216 that includes input material that deviates from the rules.

Additionally, prompts provided to generative AI models contain a finite number of tokens for receipt of data to be processed by the models. Because the tuning process produces a tuned generative AI model that has learned the set of rules, the prompts provided to the tuned generative AI model (e.g., the prompt(s) 216 of FIG. 2C) may be longer (e.g., include more information related to the content to be generated) because tokens are not consumed with rules to be enforced by the generative AI model. Also, because the tuned generative AI model has been tuned or trained using topics that are uniformly distributed (e.g., among the input data 202, synthetic data 204), the tuned generative AI model may avoid topic bias that could occur under certain training conditions. As such, tuned generative AI models configured in accordance with aspects of the present disclosure overcome the drawbacks and limitations of existing generative AI models and enable more robust usage of generative AI models across a variety of industry and business use cases.

Further, including, in synthetic training data 212, a plurality of pairs of synthetic data 204 and synthetic data 210, each pair indicative of a rule and a modified rule, respectively, a speed with which generative AI model 206 may be tuned might be greater than in conventional systems. To elaborate, since the plurality of pairs of synthetic data 204 and synthetic data 210 may approximate the totality of the rules (e.g., may be representative of the set of rules as a whole), it may be possible to avoid sampling each rule of the set of rules, while still maintaining an accuracy of tuned generative AI model 214. In this manner, by possibly obviating the need to sample each rule of the set of rules, a speed with which generative AI model 206 may be tuned might be greater than the speed with which a conventional system may be tuned.

It should be understood that sets of rules utilized to tune generative AI models in accordance with the concepts disclosed herein may be voluminous, comprising thousands, hundreds of thousands, or millions of rules. Using the techniques disclosed herein enables a generative AI model to learn such rule sets more quickly through generation of synthetic training data, thereby providing a rapid way to generate training data that may be used to more quickly produce tuned generative AI models capable of enforcing such voluminous rule sets while using reduced computational resources. Accordingly, it should be appreciated that the present disclosure facilitates accurate, precise, and reliable tuning of generative AI models as compared to traditional approaches, which struggle to produce generative AI models that have learned sets of rules and are capable of enforcing those rules when new prompts are received, such as the prompt(s) 216 of FIG. 2C.

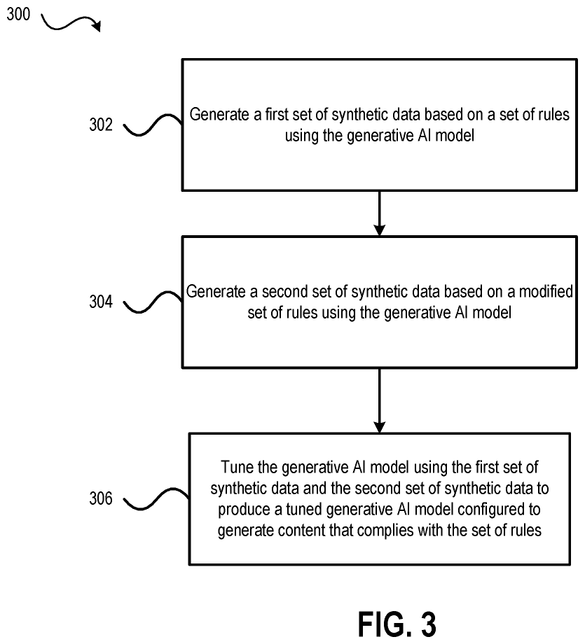

FIG. 3 is a flow diagram illustrating an example process 300 that supports tuning a generative AI model using synthetic data according to one or more aspects of the disclosure. Operations of process 300 may be performed by a content generation device, such as content generation device 110 described above with reference to FIG. 1. Example operations (also referred to as “blocks”) of process 300 may enable content generation device 110 to support tuning a generative AI model using synthetic data in accordance with processes 200A, 200B described with reference to FIGS. 2A and 2B.

At block 302, a first set of synthetic data is generated based on a set of rules using the generative AI model. For example, generative modeling engine 120 of FIG. 1 may utilize process 200A of FIG. 2A to generate the first set of synthetic data, as described above with reference to synthetic data 204 of FIG. 2A. At block 304, a second set of synthetic data is generated based on a modified set of rules using the generative AI model. For example, generative modeling engine 120 of FIG. 1 may utilize process 200A of FIG. 2A to generate the first set of synthetic data, as described above with reference to synthetic data 210 of FIG. 2A.

At block 306, the generative AI model is tuned using the first set of synthetic data and the second set of synthetic data to produce a tuned generative AI model configured to generate content that complies with the set of rules. For example, generative modeling engine 120 of FIG. 1 may utilize process 200B of FIG. 2B to tune the generative AI model by providing the generative AI model with the first set of synthetic data and the second set of synthetic data, which may cumulatively be referred to as synthetic training data. As explained above with reference to FIG. 2B, the tuning process performed at block 306 may be used to transform the generative AI model into a tuned generative AI model (e.g., tuned generative AI model 214 of FIG. 2B.). For example, the synthetic training data may include synthetic data pairs, as described above with reference to Table 1, which may include positive and negative examples (e.g., examples that do and do not comply with the set of rules or a portion thereof) obtained via the synthetic data 204, 210 of FIG. 2A.

Once the tuned generative AI model is created, at block 306, the tuned generative AI model may be utilized to generate content, as explained above with reference to FIG. 2C. For example, the tuned generative AI model may be used as a style assistant to rewrite draft content in a format that complies with the set of rules. To illustrate and referring back to FIG. 1, a user associated with computing device 130 may draft content, such as a draft blog post, press release, social media post, e-mail, or other form of content. The user may then present the draft content to the tuned generative AI model as a prompt and the tuned generative AI model may then rewrite the draft content into a form that complies with the set of rules learned by the generative AI model during the tuning process, at block 306. The output of the tuned generative AI model may then be provided to the computing device 130 where the user may use the output to publish the content (e.g., send the e-mail, post the blog article or press release, etc.). As can be appreciated from the foregoing, the method 300 enables generative AI models to be produced that are capable of learning a set of rules and then enforcing those rules during content generation in a manner that is more robust than current techniques that are incapable of training generative AI models to comply with rule sets. Moreover, because the tuned generative AI model produced by the method 300 learns the set of rules, prompts provided to the tuned generative AI model may more efficiently utilize computing resources (e.g., because the prompts provided to the tuned generative AI model may include fewer tokens because the rules can be omitted from the prompts). Accordingly, the method 300 provides a new process for creating generative AI models capable of generating content that complies with rule sets. It is noted that while many of the examples described herein are related to generation of text content, embodiments of the present disclosure may be utilized to tune other types of generative AI models (e.g., generative AI models configured to generate image content, video content, audio content, and the like) using the synthetic data generation and tuning techniques disclosed herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

One or more components, functional blocks, and modules described herein with respect to FIGS. 1-3 may include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A system for tuning a generative artificial intelligence (AI) model using synthetic data, the system comprising:
a memory; and
one or more processors communicatively coupled to the memory, the processor configured to:
generate a first set of synthetic data based on a set of rules using the generative AI model, the first set of synthetic data comprising a first plurality of content outputs generated by the generative AI model, wherein the first plurality of content outputs complies with the set of rules;
generate a second set of synthetic data based on a modified set of rules using the generative AI model, the second set of synthetic data comprising a second plurality of content outputs generated by the generative AI model, wherein the second plurality of content outputs complies with the modified set of rules but not the set of rules; and
tune the generative AI model using the first set of synthetic data and the second set of synthetic data to produce a tuned generative AI model configured to generate content that complies with the set of rules.

2. The system of claim 1, wherein each content output of the first plurality of content outputs is generated based on a different portion of the set of rules, and wherein each content output of the second plurality of content outputs is generated based on a different portion of the modified set of rules.

3. The system of claim 2, the one or more processors configured to:
receive one or more prompts, each prompt of the one or more prompts corresponding to a particular content output of the first plurality of content outputs and comprising one of the different portions of the set of rules and information associated with a topic, wherein each content output of the first plurality of content outputs comprises content associated with the topic included in the corresponding prompt.

4. The system of claim 1, wherein the second set of synthetic data is generated based on the modified set of rules and the first set of synthetic data.

5. The system of claim 1, wherein the processor is further configured to:
provide a prompt to the tuned generative AI model as an input; and
receive first content from the tuned generative AI model, wherein the first content corresponds to the prompt and complies with the set of rules.

6. The system of claim 1, the one or more processors configured to generate a plurality of synthetic data pairs, each synthetic data pair of the plurality of synthetic data pairs comprising first content output and a second content output, the first content output selected from among the first plurality of content outputs and the second content output selected from among the second plurality of content outputs.

7. The system of claim 6, wherein the one or more processors are configured to tune the generative AI model based, at least in part, on the plurality of synthetic data pairs, wherein, during the tuning, the second content output of a particular synthetic data pair corresponds to an input to the generative AI model and the first content output of the particular synthetic data pair corresponds to a desired output of the generative AI model.

8. The system of claim 1, wherein the generative AI model and the tuned generative AI model comprise a large language model (LLM), an image generator model, a video generator model, or combinations thereof.

9. The system of claim 1, wherein the set of rules comprises rules for generation of textual content, rules for generation of image content, rules for generation of video content, or combinations thereof.

10. The system of claim 1, wherein the one or more processors are configured to:
receive an updated set of rules;
generate new first synthetic data and new second synthetic data in response to receiving the updated set of rules; and
tune the generative AI model or the tuned generative AI model based on the new first synthetic data and the new second synthetic data to produce an updated tuned generative AI model.

11. A method for tuning a generative artificial intelligence (AI) model using synthetic data, the method comprising:
generating a first set of synthetic data based on a set of rules using the generative AI model, the first set of synthetic data comprising a first plurality of content outputs generated by the generative AI model, wherein the first plurality of content outputs complies with the set of rules;
generating a second set of synthetic data based on a modified set of rules using the generative AI model, the second set of synthetic data comprising a second plurality of content outputs generated by the generative AI model, wherein the second plurality of content outputs complies with the modified set of rules but not the set of rules; and
tuning the generative AI model using the first set of synthetic data and the second set of synthetic data to produce a tuned generative AI model configured to generate content that complies with the set of rules.

12. The method of claim 11, wherein each content output of the first plurality of content outputs is generated based on a different portion of the set of rules, wherein each content output of the second plurality of content outputs is generated based on a different portion of the modified set of rules, and wherein the method further comprises:
receiving one or more prompts, each prompt of the one or more prompts corresponding to a particular content output of the first plurality of content outputs and comprising one of the different portions of the set of rules and information associated with a topic, wherein each content output of the first plurality of content outputs comprises content associated with the topic included in the corresponding prompt.

13. The method of claim 11, wherein the second set of synthetic data is generated based on the modified set of rules and the first set of synthetic data, and wherein the method further comprises:
providing a prompt to the tuned generative AI model as an input;
receiving first content from the tuned generative AI model, wherein the first content corresponds to the prompt and complies with the set of rules;
receiving an updated set of rules;
generating new first synthetic data and new second synthetic data in response to receiving the updated set of rules; and
tuning the generative AI model or the tuned generative AI model based on the new first synthetic data and the new second synthetic data to produce an updated tuned generative AI model.

14. The method of claim 11, further comprising:
generating a plurality of synthetic data pairs, each synthetic data pair of the plurality of synthetic data pairs comprising first content output and a second content output, the first content output selected from among the first plurality of content outputs and the second content output selected from among the second plurality of content outputs, wherein tuning the generative AI model using the first set of synthetic data and the second set of synthetic data comprises:
tuning the generative AI model based, at least in part, on the plurality of synthetic data pairs, wherein, during the tuning, the second content output of a particular synthetic data pair corresponds to an input to the generative AI model and the first content output of the particular synthetic data pair corresponds to a desired output of the generative AI model.

15. A non-transitory computer-readable storage medium storing instructions that, when executed by one or more processors, cause the one or more processors to perform operations for tuning a generative artificial intelligence (AI) model using synthetic data, the operations comprising:
generating a first set of synthetic data based on a set of rules using the generative AI model, the first set of synthetic data comprising a first plurality of content outputs generated by the generative AI model, wherein the first plurality of content outputs complies with the set of rules;
generating a second set of synthetic data based on a modified set of rules using the generative AI model, the second set of synthetic data comprising a second plurality of content outputs generated by the generative AI model, wherein the second plurality of content outputs complies with the modified set of rules but not the set of rules; and
tuning the generative AI model using the first set of synthetic data and the second set of synthetic data to produce a tuned generative AI model configured to generate content that complies with the set of rules.

16. The non-transitory computer-readable storage medium of claim 15, wherein each content output of the first plurality of content outputs is generated based on a different portion of the set of rules, wherein each content output of the second plurality of content outputs is generated based on a different portion of the modified set of rules, and wherein the operations further comprise:
receiving one or more prompts, each prompt of the one or more prompts corresponding to a particular content output of the first plurality of content outputs and comprising one of the different portions of the set of rules and information associated with a topic, wherein each content output of the first plurality of content outputs comprises content associated with the topic included in the corresponding prompt.

17. The non-transitory computer-readable medium of claim 15, wherein the second set of synthetic data is generated based on the modified set of rules and the first set of synthetic data, and wherein the operations further comprise:
providing a prompt to the tuned generative AI model as an input;
receiving first content from the tuned generative AI model, wherein the first content corresponds to the prompt and complies with the set of rules;
receiving an updated set of rules;
generating new first synthetic data and new second synthetic data in response to receiving the updated set of rules; and
tuning the generative AI model or the tuned generative AI model based on the new first synthetic data and the new second synthetic data to produce an updated tuned generative AI model.

18. The non-transitory computer-readable medium of claim 15, wherein the operations further comprise:
generating a plurality of synthetic data pairs, each synthetic data pair of the plurality of synthetic data pairs comprising first content output and a second content output, the first content output selected from among the first plurality of content outputs and the second content output selected from among the second plurality of content outputs.

19. The non-transitory computer-readable medium of claim 18, wherein tuning the generative AI model using the first set of synthetic data and the second set of synthetic data comprises:
tuning the generative AI model based, at least in part, on the plurality of synthetic data pairs, wherein, during the tuning, the second content output of a particular synthetic data pair corresponds to an input to the generative AI model and the first content output of the particular synthetic data pair corresponds to a desired output of the generative AI model.

20. The non-transitory computer-readable medium of claim 15, wherein the generative AI model and the tuned generative AI model comprise a large language model (LLM), an image generator model, a video generator model, or combinations thereof, and wherein the generative AI model and the tuned generative AI model comprise a large language model (LLM), an image generator model, a video generator model, or combinations thereof.
